(19) United States
(12) Patent Application Publication
(10) Pub. No.: US 2002/0022096 A1
(43) Pub. Date: Feb. 21, 2002

(54) Barrier laminate for juice packaging

(76) Inventor: James F. Curtis, Clyde, NC (US)

Correspondence Address: DORITY & MANNING, P.A., POST OFFICE BOX 1449, GREENVILLE, SC, 29602-1449, US

(21) Appl. No.: 09/840,547

(22) Filed: Apr. 23, 2001

Related U.S. Application Data
(63) Continuation of application No. 09/173,226, filed on Oct. 15, 1998, now abandoned.

(51) Int. Cl. B32B 1/02

(52) U.S. Cl. 428/34.2; 428/513; 428/479.6

(57) ABSTRACT

A barrier structure for food and juice packages is provided by an EVOH barrier layer blended with an amorphous polyamide. The barrier layer is applied to a paperboard substrate as part of a multiple layer coating used on the interior of a food beverage package.

### BACKGROUND OF THE INVENTION

This invention relates to barrier laminates for use in juice packaging, the cartons or containers made from those barrier laminates, as well as to a method of making such laminates. More particularly the invention relates to a paperboard barrier laminate which makes use of an inner barrier layer of an ethylene vinyl alcohol-polyamide blend in order to enhance the barrier properties of the laminate.

Glass containers have been used for many years to store and transport juice and milk, but have a number of disadvantages including shipping costs for the empty containers, disposal problems, breakage and weight problems. Similarly, blow molded plastic containers for juices and milk are also available, but the empty containers are comparatively expensive to transport and do not prevent loss of vitamin C from a juice product contained in them. In addition manufacturing costs for such all-plastic containers can be prohibitive since expensive equipment is involved in their manufacture.

The advantages of comparattively low container weight, ease of sealing and opening, ease of disposal and low shipping volume for the empty containers (since the containers can be shipped in a collapsed condition), make containers based on a paperboard substrate the current favored choice for marketing juice products and milk. These containers are known in the trade as “gable top”, containers or cartons.

For example, one such carton, or gable-top milk carton, is described in U.S. Pat. No. 3,120,333. Blanks used to make this carton include a paperboard base, which is extrusion coated with resin on both sides. The resin, which may be polyethylene, provides a moisture barrier and means for heat-sealing the carton.

In a typical carton converting operation, once the resin-blanks are scored and cut, the resin on an outer surface of a glue flap and the resin on an inner surface of a carton panel are heated by direct flame application. The carton panels are then folded over to form a flattened tube, the now molten tacky resin on the heated surfaces are pressed together at a downstream nip to form a liquid-tight seam. The cartons, in a flattened tube form, can then be shipped to users such as juice manufacturers or dairies where they are erected, the bottoms heat sealed, filled and their tops finally sealed.

Although considerations of cost make paperboard containers desirable for containing fruit juices and milk, other factors are also important. These involve the choice of a suitable barrier (laminate) for carton construction for retenion of flavor and vitamin content during storage. The effect of diffusion of oxygen into the liquid in the container through the barrier laminate and absorption of essential oils from the liquid into the laminate, remain important considerations in the choice of a suitable laminate.

Laminates containing a metal foil have been used to make a foldable paperboard-based carton for a juice product. These metal foil-containing containers do retain the vitamin content and flavors in the juice for a substantial period of time (around ten weeks), but are expensive compared to containers that do not require a metal foil in the laminate from which they are made. Further, metal foil laminates are prone to develop pin holes seriously affecting their ability to contain liquids. Thus, considerable effort has been devoted to finding the best layer structure in a barrier laminate.

A further advance in the art of making a juice or milk carton resulted from the introduction of a laminate, which also provided an effective barrier for oxygen and thus helped retain vitamin C in the juice stored in a carton made from it. This laminate, which is described in U.S. Pat. No. 4,777,088, comprises from the outer surface to the inner surface, an outer polyolefin coating that provides the heat seal bond, a paperboard substrate that provides the structure of the carton, a nylon layer coated directly on the paperboard substrate, a layer of modified polyethylene (Bynel E 388) directly overlying and in contact with the nylon layer and an inner polyolefin layer in contact with the modified polyethylene layer. Not only does the nylon barrier layer in this laminate help retain vitamin C, but also the laminate helps retain essential oils and flavor.

Other barrier laminates capable of excluding oxygen and preventing loss of oils and/or flavors are described in U.S. Pat. Nos. 4,701,360, 4,861,526 and 4,698,246 in which both sides of a paperboard substrate are first flame treated and a layer of low density polyethylene (LDPE) then applied to the outside surface. To the surface of the paperboard which becomes the inside surface of the carton, first, a layer of low density polyethylene is applied directly to the paperboard. Then a nylon barrier layer is applied to that interior low density polyethylene layer with a bonding tie layer between the nylon and polyethylene. Finally, an innermost skin layer is applied to the nylon with another tie layer to improve the adhesion of the layers and to help in heat sealing. A preferred skin layer is ethylene vinyl alcohol polymer. This process is comparatively complicated and involves a substantial number of layers.

Other existing commercial structures heat-sealable barrier laminates providing a substantial barrier to the loss of Vitamin C and an almost complete barrier to the loss of essential flavor oils over the shelf life period of the carton (six weeks) and far beyond the six week period as well have been proposed. For example U.S. Pat. Nos. 4,701,360 and 4,950,510 teach barrier laminates including from the outer surface to the inner surface contacting the juice containing essential oils and/or flavors, an exterior layer of a low density polyethylene, a paperboard substrate, an interior layer of a low density polyethylene and a layer of ethylene vinyl alcohol copolymer (EVOH) coated onto the interior layer of low density polyethylene on the interior surface of the paperboard substrate, in contact with the juice rendering the laminate heat-sealable.

U. S. Pat. Nos. 4,990,562, 5,126,401 and 5,126,402 describe blends of ethylene vinyl alcohol copolymer with an amorphous polyamide component and their use as barrier layers in multilayer containers formed by deformation processes. Examples of deformation processes include thermoforming (excluding melt phase thermoforming), vacuum-forming, solid phase pressure forming, co-injection blow molding, co-injection stretch blow molding, tube extrusion followed by stretching, scrapless forming, forging, and tubular or flat sheet oriented film processes. Examples of articles that can be prepared using deformation processes are films and containers such as bottles, jars, cans, bowls, trays, dishes, pouches, oriented films, and shrink films.

The ethylene vinyl alcohol-polyamide blends described in the U.S. Pat. No. 5,126,401 are comprised of about 5 to about 95 percent by weight of an ethylene vinyl alcohol copolymer having a copolymerized ehthylene content of about 20 to about 60 mole percent and a degree of saponification of at least about 90%, and about 95 to about 5 percent by weight of a polyamide blend consisting essentially of about 35 to about 95 percent by weight of at least one amorphous polyamide having a glass transition temperature of up to about 160 degree(s) C and about 5 to about 65 percent by weight of at least one semicrystalline polyamide which has a methylene group/amide group ratio of about 5.5 to about 7.5 and which forms separate domains when blended with said ethylene vinyl alcohol copolymer.

It is an object of the present invention to provide a comparatively economical barrier laminate for juice and/or milk cartons of the above described kind, this barrier laminate having an oxygen barrier layer that protects from oxygen degradation of essential nutrient and vitamin components, particularly Vitamin C, and a skin coating or layer that prevents loss of essential oils and/or flavor.

According to the present invention, the preferred laminate providing an effective barrier to the intrusion of oxygen and migration of essential oils and/or flavorings and for the retention of Vitamin C, essential oils and flavor in fruit juices comprises from the outer surface to the inner surface contacting the juice or other liquid, a first exterior layer of a low density polyethylene polymer, a paperboard substrate and an interior layer of a blend of ethylene vinyl alcohol copolymer (“EVOH”) and an amorphous polyamide, wherein the blend provides separate domains of EVOH and polyamide. Preferably, the blend comprises (a) about 5 to about 95% by weight of an ethylene vinyl alcohol copolymer having a copolymerized ethylene content of about 20 to about 60 mole % and a degree of saponification of at least about 90%, and (b) about 95 to about 5% by weight of an amorphous polyamide having a glass transition temperature in the range of about 80 degrees to 100 degrees C. These EVOH/polyamide blends are disclosed in U. S. Pat. Nos. 4,990,562, 5,126,407 and 5,286,575 issued to E. I. DuPont de Nemours and Company and the disclosures of these patents are hereby incorporated by reference herein.

In accordance with a second embodiment of the present invention the composite structure comprises from the outer surface to the inner surface contacting the juice or other liquid, a first exterior layer of a low density polyethylene polymer, a paperboard substrate a layer of low density polyethylene polymer and an interior layer of the blend of EVOH and polyamide as described above.

A third embodiment of the present invention comprises the addition of a layer of one of EVOH, polyethyleneterephthalate, polyethylene isophthalate, acid or glycol-modified copolymers of polyethylene terephthalate and polyethylene isopthalate, polyamides, polycaprolactans and polycarbonates as a skin layer.

Another embodiment substututes for the first exterior layer of low density polyethylene an extrudable adhesive resin such as Plexar, a modified polyolefin or modified copolymer of an olefin such as ethylene or ethylene vinyl acetate.

In still another embodiment a tie layer acting as an adherent may be interposed between the paperboard and the blend or between the interior low density polyethylene layer and the blend or between the blend and the skin layer. Examples of suitable tie layer materials include Plexar, modified polyolefin or modified copolymers of an olefin such as ethylene or ethylene vinyl acetate.

### BRIEF DESCRIPTION OF THE DRAWINGS

FIG. 1 is a cross sectional elevation of an embodiment of the laminate of the invention;

FIG. 2 is a cross sectional elevation of an alternate embodiment of the laminate of the present invention;

FIG. 3 is a cross sectional elevation of an alternate embodiment of the laminate of the present invention;

FIG. 4 is a cross sectional elevation of an alternate embodiment of the laminate of the present invention;

FIG. 5 is a cross sectional elevation of an alternate embodiment of the laminate of the present invention;

FIG. 6 is a cross sectional elevation of an alternate embodiment of the present invention;

FIG. 7 is a cross sectional elevation of an alternate embodiment of the present invention; and

FIG. 8 is a cross sectional elevation of an alternate embodiment of the present invention.

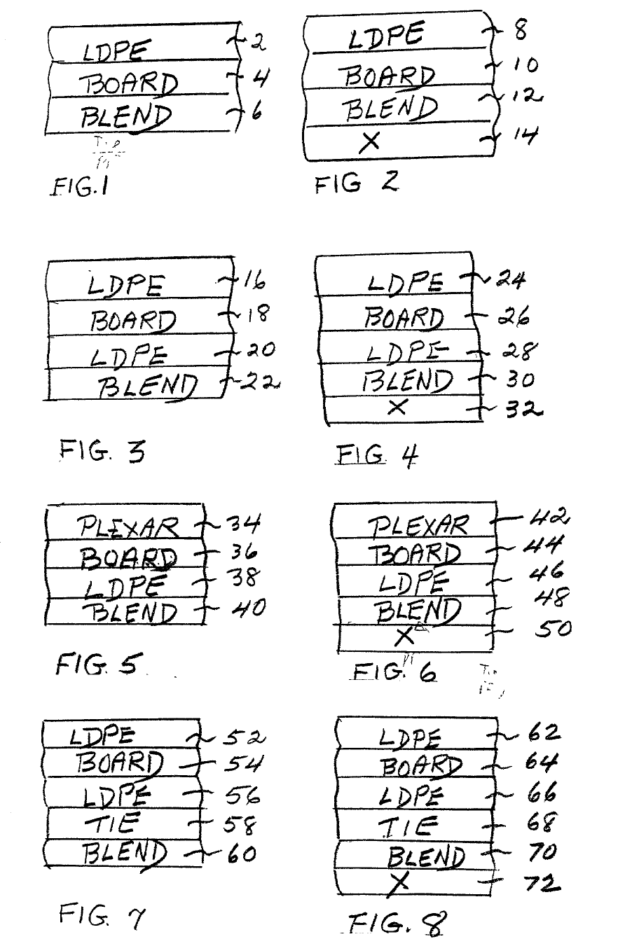

Referring to FIG. 1 the laminate of the present invention is shown as comprising a paperboard substrate 4 which is most suitably high-grade paperboard stock such as 0.010 to 0.028 milk carton stock for example, 282 lb. Mark Carton Board to which is applied on the exterior portion of the laminate, a coating of low density polyethylene 2 in a coating weight ranging from about 5 to about 20 pounds per ream. Any commercial extrusion coating grade LDPE is suitable for use herein for example Gulf 4517 polyethylene available from Gulf Oil Chemicals Company, Houston, Tex. On the back or interior portion of the board there is applied a layer of the blend of EVOH and polyamide.

Referring now to FIG. 3 depicting an alternate embodiment of the laminate of the present invention. In this alternate embodiment, the paperboard substrate 18 is coated on the external surface thereof with a layer of heat sealable LDPE 16. On the internal surface of the paperboard substrate there is applied a layer of LDPE 20. Overlying the LDPE layer 20 is a layer of the blend of EVOH and polyamide 22.

FIG. 5 discloses an embodiment of the laminate of the invention which has as the exterior layer applied on the paperboard 36 a layer of Plexar 34. On the back or interior portion of the paperboard 36, there is applied a layer of LDPE. Overlaying the LDPE layer is a layer of the blend of EVOH and polyamide. The modified polyolefin, or more correctly, the outer polyolefin layer modified to be compatible with and heat sealable to the inner product-contact barrier material is preferably selected from a group of materials identified by the trademark PLEXAR, and more particularly, PLEXAR 177 or PLEXAR 175. The PLEXARS 175 and 177 are modified, low density polyethylene-based adhesives which provide strong bonds to ethylene vinyl alcohol copolymers (EVOH), high and low density polyethylenes, ethylene copolymers, paper and paperboard. They are suitable for both coextrusion coating and cast film coextrusion. The tie layers used in the alternative embodiment of the present invention would also preferably be PLEXARS. The PLEXAR class of adhesives are available from USI Corporation and are fully described in U.S. Pat. Nos. 4,087,587 and 4,087,588.

FIG. 7 discloses another embodiment of the present invention which makes use of a paperboard substrate 54 sandwiched between two layers of low density polyethylene (LDPE) 52, 56. Overlying the LDPE layer 56 is a tie layer 58 such as Plexar 177 or a coextruded sandwich of Plexar 177, EVOH and LDPE. A suitable extrusion coatable adhesive may be substituted for the tie layer such as DuPont's cXa's or Shell's Kratons or copolymers of ethylene and methacrylic acid. On the interior portion of the laminate, namely onto the tie layer there is applied a layer of the EVOH and polyamide blend 60.

FIGS. 2, 4, 6 and 8 correspond to FIGS. 1, 3, 5 and 7 respectively except that an additional layer X is utilized in addition to the layers disclosed in FIGS. 1, 3, 5 and 7 as the interior layer for adding greater barrier resistance to the passage of oxygen and resultant loss of Vitamin C and which enhances flavor retention. This innermost layer X can be any of EVOH polyethylene isophthalate, polyethylene terephthalate, acid or glycol-modified copolymers polyethylene terephthalate and polyethylene isophthalate, polyamides, polycaprolactams and polycarbonates.

The laminates of the present invention can be easily fabricated. For example the layers can be directly extruded onto the paperboard substrate or other layer as disclosed above. In the case of the use of the tie layer for facilitating adhesion, the LDPE and the tie layer can be directly coextruded on to the paperboard substrate or the various layers of the multiple layer structures may be held together by any of a variety of adhesive resins. In general, such adhesive resins are polymers having carbonyl groups derived from functional groups of free carboxylic acids, carboxylic acid salts, carboxylic acid esters, carboxylic acid amides, carboxylic anhydrides, carbonic acid esters, urethanes, ureas or the like. Suitable adhesive resins include polyolefins modified with at least one ethylenically unsaturated monomer selected from unsaturated carboxylic acids and anhydrides, esters and amides thereof especially polypropylene, high density polyethylene, low density polyethylene and ethylene-vinyl acetate copolymers modified with at least one member selected from acrylic acid, methacrylic acid, crotonic acid, fumaric acid, itaconic acid, maleic anhydride, itaconic anhydride, citraconic anhydride, ethyl acrylate, methyl methacrylate, ethyl maleate, 2-ethyethexyl acrylate, acrylamide, methacrylamide, fatty acid amides, and imides of the acids described above. The adhesive can also be prepared from an ethylene polymer and a second polymer grafted with maleic anhydride, as disclosed in U.S. Pat. No. 4,230,830, the disclosure of which is incorporated herein by reference. In addition, as the adhesive resin, there can be used ethylene-acrylate copolymers, ionomers, polyalkylene oxide-polyester block copolymers, carboxy-methyl cellulose derivatives, and blends of these polymers with polyolefins.

Both the use of flame treatment and corona discharge or the like can be used where it is desired to enhance adhesion. It should be apparent to those skilled in the art that any conventional techniques for applying the overlying layers to the paperboard substrate and to each other can be suitably employed.

The effectiveness of the laminates of the present invention is in part due to their functioning as a barrier to mifration of essential oils and flavors, their increased barrier resistance to oxygen so that Vitamin C is not lost and their acting as a barrier to other gases such as carbon dioxide and various aromas. The laminates of the invention not only have the advantages of the improved barrier properties which extend the shelf life of the juice but that the laminates can be produced using conventional blending and extrusion equipment.

That which is claimed:

1. A container for liquids containing essential oils, flavors and Vitamin C, said container constructed from a laminate comprising:
(a) a paperboard substrate
(b) an outer layer of a member selected from the group consisting of heat-sealable low density polyethylene polymers and Plexar, coated on the outer surface of said paperboard substrate; and
(c) an inner layer of a blend comprising about 5 to about 95 percent by weight of an ethylene vinyl alcohol copolymer (“EVOH”) having a copolymerized ethylene content of about 20 to about 60 mole percent and a degree of saponificaton of at least about 90%; and about 95 to about 5 percent by weight of an amorphous polyamide having a glass transition temperture in the range of about 80 degree(s) to 100 degree(s) C., wherein the resulting blend provides separate domains of EVOH and polyamide.

2. A container according to claim 1 wherein said laminate has a layer of low density polyethylene polymer coated on said inner surface of said paperboard substrate.

3. A container according to claim 2 wherein said laminate has an inner tie layer coated on said inner surface of said inner layer of low density polyethylene.

4. A container according to claim 3 wherein said tie layer is a member selected from the group consisting of Plexar, copolymers of ethylene and methacrylic acid, modified polyolefin, modified copolymer of an olefin, and ethylene vinyl acetate.

5. A container according to claim 1 wherein a skin layer is applied to the surface of said blend in contact with said liquid.

6. A container according to claim 5 wherein said skin layer is a member selected from the group consisting of ethylene vinyle alcohol copolymer (EVOH), polyethyleneterephthalate, polyethyleneisopthalate, acid or glycol-modified copolymers of polyethyleneterephthalate, polyethylene isophthalate, polyamides, polycaprolactams and polycarbonates.

7. A container according to claim 1 wherein said outermost layer of said laminate is a heat sealable low density polyethylene polymer.

8. A container according to claim 1 wherein said outermost layer of said laminate is Plexar.

9. A multiple layer structure comprising:
(a) a paperboard substrate;
(b) an outer layer of a member selected from the group consisting of a heat sealable low density polyethylene and Plexar coated on the outer surface of said paperboard substrate; and
(c) an inner layer of a blend comprising; about 5 to about 95 percent by weight of an ethylene vinyl alcohol copolymer (“EVOH”) having a copolymerized ethylene content of about 20 to about 60 mole percent and a degree of saponification of at least about 90%; and about 95 to about 5 percent by weight of an amorphouse polyamide having a glass trnasition temperature in the range of about 80 degree(s) to 100 degree(s) C., wherein the resulting blend provides separate domains of EVOH and polyamide.

10. A multiple layer structure according to claim 9 wherein an inner layer of LDPE is interposed between said paperboard substrate and said inner layer of the blend of EVOH and polyamide.

11. A multiple layer structure according to claim 10 wherein a tie layer is coated onto said inner layer of LDPE and said layer of the blend of EVOH and polyamide.

12. A multiple layer structure according to claim 11 wherein said tie layer is a member selected from the group consisting of Plexar, copolymers of ethylene and methacrylic acid, modified polyolefin, modified copolymer of an olefin, and ethylene vinyl acetate.

13. A multiple layer structure according to claim 11 wherein a skin layer is applied onto the outermost surface of said blend.

14. A multiple layer structure according to claim 13 wherein said skin layer is a member selected from the group consisting of ethylene vinyl alcohol copolymer (EVOH), polyethyleneterephthalate, polyethyleneisophthalate, aicd or glycol-modified copolymers of polyethyleneterephthalate, polyethyleneisophthalate, polyamides, polycaprolactams and polycarbonates.

15. A multiple layer structure according to claim 9 wherein said outer layer is low density polyethylene.

16. A multiple layer structure according to claim 9 wherein said layer is Plexar.
